(19) United States
(12) Patent Application Publication
(10) Pub. No.: US 2023/0225541 A1
(43) Pub. Date: Jul. 20, 2023

(54) DISC-SHAPED AUTOMATIC COOKING APPARATUS, AND METHOD OF OPERATING THE SAME

(71) Applicant: Madhura Priya SENTHILNATHAN, Chennai, Tamil Nadu (IN)

(72) Inventors: Madhura Priya SENTHILNATHAN, Chennai, Tamil Nadu (IN); L. SENTHILNATHAN, Chennai, Tamil Nadu (IN)

(21) Appl. No.: 17/998,389

(22) PCT Filed: May 10, 2021
(86) PCT No.: PCT/IN2021/050450

§ 371 Date: Nov. 10, 2022

(30) Foreign Application Priority Data
May 11, 2020 (IN) 202041019823

(51) Int. Cl. A47J 27/00; A47J 36/14; A47J 36/34; A47J 47/01

(52) U.S. Cl. CPC A47J 27/004; A47J 36/14; A47J 36/34; A47J 47/01

(57) ABSTRACT

Described herein is an automatic cooking apparatus (100) and a method of operating the same. The apparatus comprises a planar heating means, such as a heater plate (102a), which can be placed and operated in an inclined position and rotates about its axis. A dispensing mechanism (104) comprising a storage tank (112) automatically dispenses a desired quantity of a semi-solid liquid substance on the heating surface under gravitational force. The heater plate, in the course of dispensing of the semi-solid liquid substance on the heating surface, rotates about its axis to spread the semi-solid liquid substance on the heating surface, and attains one or more cooking positions after the semi-solid liquid substance is suitably spread on the heating surface for cooking the semi-solid liquid substance. The removal of cooked food item (156′) is performed by an elongated blade (106) by further rotating the heater plate in the same direction.

### TECHNICAL FIELD

The present subject matter, in general, relates to an automatically operated cooking apparatus and in particular, relates to a disc-shaped cooking apparatus for automatic dispensing, spreading and cooking of raw ingredients comprising semi-solid liquid substance, and serving the food item thus prepared.

### BACKGROUND

Cooking of food items, especially those prepared from semi-solid liquid raw ingredients, is generally performed manually due to complex steps and requirement of controlled parameters, such as temperature, thickness of food products, ingredient levels, uniform mixing and spreading etc. Conventional cooking apparatuses are customarily available to perform one step of multi-level steps required for food preparation at any given time. Performing of several steps of cooking simultaneously along with controlling of afore-mentioned parameters requires an arduous labor and is relatively quiet time consuming. Some conventional apparatuses are required to be manually tilted in varying positions for facilitating collection and spreading of raw material onto the heating surface. Even after all cooking steps are complete, serving of cooked food item requires precise handling by the user. In conventional apparatuses, cooked food item has to be manually lifted off the cooking surface and served on a plate. This requires the user to carefully handle the cooked food item while transferring it to a serving dish. Some conventional apparatuses can also be tilted manually for transferring the cooked food item onto the serving dish. This requires the user to handle the cooking apparatus with great caution. There is a risk of injury to the user if the hot surface of the apparatus comes in direct contact with the user. In some conventional apparatuses, if cooked food item is not removed from the cooking surface in a timely manner and the food item is subjected to heat longer than necessary, there is a risk of burning the food item.

Therefore, a great amount of human intervention is required even for cooking a food item in an automatic cooking apparatus known in the art. Further, uneven application of raw ingredients on a heating surface results in uneven thickness and roast levels of the final food item, and in irregular control of degree of heat applied to the food item, thereby affecting the flavor and texture characteristics of the cooked food item.

In the case of food products such as dosa, crepes, pancakes etc., the temperature of a cooking surface plays a vital role when the batter is spread over said surface. If the cooking surface is too hot, the raw material sticks to the surface as soon as said it comes in contact with the cooking surface. This makes the process of spreading of batter very difficult and may result in a thicker final food product. Also, there are chances that the finally cooked food product does not come off the surface in a clean manner from the cooking surface. In order to mitigate these problems, the cooking surface of the conventional apparatus is generally greased with oil or a cooking spray before dispensing a raw material or batter. However, this renders the food item unhealthy.

Moreover, during operation, the heated cooking surface of a conventional cooking apparatus remains unused during the interval when the cooked food item has been removed from the surface, but next batch of raw material is yet to be dispensed and spread on the surface. This makes the cooking process energy inefficient and time consuming.

In some conventional apparatuses, the cooking components are fixed permanently and cannot be removed for cleaning. This makes the cleaning of components cumbersome.

Fully automatic cooking apparatuses which perform more than one step of cooking a food item are also known. However, such cooking apparatuses are restricted to cooking only one type of food item or different food items of same category. Even for a single type of food item preparation, separate components/sub-assemblies are employed by such fully automatic apparatuses for performing different cooking steps. Having large number of components/sub-assemblies for separate cooking steps puts a question mark on the reliability of such apparatuses. Further, large number of moving parts add to the challenges of reduced working life cycle and efficiency of such fully automatic cooking apparatuses. Moreover, sound and vibrations due to multiple moving parts play quiet a decisive role in selection of a cooking apparatus by customers.

Therefore, there is a well felt need for a fully automatic cooking apparatus that is simple and economical and at the same time is able to automatically perform complex cooking techniques of different type of food items as well as food items of different categories in an efficient and reliable manner without compromising its safety and stability. Further, it is desired to provide an automatic cooking apparatus and method which is capable of achieving uniform dispensing and controlling of cooking substance in an easy, controlled and cost-effective manner with minimum moving components.

### SUMMARY

An object of the present subject matter is to provide a disc-shaped automatic cooking apparatus that requires no human intervention in cooking a food item.

Yet another object of the present subject matter is to provide a disc-shaped automatic cooking apparatus that is capable of achieving desired flavor and texture characteristics of food items.

Yet another object of the present subject matter is to provide a disc-shaped automatic cooking apparatus that is capable of cooking different types of food items.

Yet another object of the present subject matter to provide a disc-shaped automatic cooking apparatus, which is capable of achieving uniform dispensing and controlling of cooking substance in an easy and cost-effective manner with the help of gravitational force.

Yet another object of the present subject matter is to provide a disc-shaped automatic cooking apparatus, which ensures continuous monitoring of vital cooking parameters such as thickness of product, roast levels, quantity of raw material to be supplied, measuring of different kinds and variety of ingredients and so on.

Yet another object of the present subject matter is to provide a compact disc-shaped automatic cooking apparatus, which is capable of being positioned at various angles to facilitate feeding and collection of cooking substance in an easy and smooth manner.

Yet another object of the present subject matter is to provide a disc-shaped automatic cooking apparatus which is capable of automatically removing the cooked product cleanly from the cooking surface and transferring it to a serving dish.

Yet another object of the present subject matter is to provide a disc-shaped automatic cooking apparatus in which a food item can be prepared without the repeated use of oil or cooking sprays.

Yet another object of the present subject matter is to provide a disc-shaped automatic cooking apparatus that is configured to cook a large number of food items in a short time.

Yet another object of the present subject matter is to provide a disc-shaped automatic cooking apparatus with detachable components, which can be cleaned easily.

Yet another object of the present subject matter is to provide a compact disc-shaped automatic cooking apparatus, which is capable of facilitating cooking of conical shaped food items without requiring special skills of a user.

Yet another object of the present subject matter is to provide a disc-shaped automatic cooking apparatus with reduced moving parts and hence, reduced sound and vibrations.

Yet another object of the present subject matter is to provide a disc-shaped automatic cooking apparatus with reduced components/sub-assemblies for performing cooking operation.

Yet another object of the present subject matter is to provide a disc-shaped automatic cooking apparatus that is reliable, efficient and has long service life.

Yet another object of the present subject matter is to provide a disc-shaped automatic cooking apparatus that is economical, simple and safe to operate.

Yet another object of the present subject matter is to provide a disc-shaped automatic cooking apparatus, which is capable of efficiently controlling levels of heat to be applied to different kinds of food product.

Yet another object of the present subject matter is to provide a disc-shaped automatic cooking apparatus, which is energy efficient.

Yet another object of the present subject matter is to provide a disc-shaped automatic cooking apparatus, which is capable of performing various cooking operations parallelly thereby saving time.

Yet another object of the present subject matter is to provide a disc-shaped automatic cooking apparatus, which is capable of being operated as a regular induction stove to cook variety of food items.

Described herein is an automatic cooking apparatus comprising at least one planar heating means configured to be placed and operated in at least one inclined position and to rotate about its axis, the at least one planar heating means comprising at least one planar heating surface; and at least one dispensing mechanism for automatically dispensing, under gravitational force, a desired quantity of at least one semi-solid liquid substance on the at least one heating surface; the at least one planar heating means, in the course of dispensing of the at least one semi-solid liquid substance on the at least one heating surface, rotates about its axis to spread the at least one semi-solid liquid substance on at least a part of the at least one heating surface, and attains one or more cooking positions after the at least one semi-solid liquid substance is suitably spread on the at least a part of the at least one heating surface for cooking the at least one semi-solid liquid substance.

In an embodiment, at least one planar heating means comprises a disc- or elliptical- or polygon-front heater plate having plane or concave or convex cooking surface.

In another embodiment, the at least one planar heating means is configured to be placed and operated in vertical position, inclined position and horizontal position, and also to rotate in clockwise and/or anticlockwise by about 360 degrees or less than 360 degrees.

In yet another embodiment, the at least one inclined position comprises an angular position of the at least one planar heating means between 0 to 90 degrees, preferably 0 degrees and between 60 to 90 degrees from horizontal.

In yet another embodiment, at least one adjustable stand is provided to hold the at least one planar heating means at varying angles in said inclined position, particularly at 60 degrees and 90 degrees from horizontal.

In yet another embodiment, the at least one dispensing mechanism comprises at least one storage tank for dispensing the at least one semi-solid liquid substance on the at least one heating surface, and wherein the at least one storage tank is configured to flip towards and away from the at least one planar heating means by a feeder drive assembly.

In yet another embodiment, the feeder drive assembly comprises a motor operated, or solenoid actuator operated or cam operated feeder drive assembly or a feeder drive assembly operated by any other actuating mechanism.

In yet another embodiment, the cooking apparatus further comprises an elongated blade removably mounted in the radial direction on the cooking surface of the at least one planar heating means for removing or peeling a cooked food item, prepared by cooking the at least one semisolid liquid substance on the at least one heating surface, from the at least one heating surface when the at least one planar heating means further rotates about its axis from the cooking position in the same direction such that the cooked food item removed from the at least one planar heating means has a conical shape.

In yet another embodiment, the cooking apparatus further comprises a plate support frame mounted besides the at least one planar heating means for supporting the at least one planar heating means, as well as housing a heater plate rotating assembly and an electrical heating assembly, and wherein the at least one planar heating means is detachable from the plate support frame.

In yet another embodiment, the heater plate rotating assembly is operated by a gear mechanism or a belt mechanism or any other mechanism that enables rotation of the at least one planar heating means.

In yet another embodiment, the electrical heating assembly comprises one or more heating elements comprising a tubular heating coil, or an induction coil mounted besides the at least one planar heating means for supplying heat to the at least one planar heating means, and wherein the cooking apparatus with induction coil as heating element, once detached from the plate support frame, is configured to be used manually in a horizontal plane.

In yet another embodiment, the angle between the feeder tank and the elongated blade is in the range of 180 to 280 degrees, preferably about 270 degrees.

In yet another embodiment, the cooking apparatus further comprises provisions for mounting the automatic cooking apparatus on a wall.

Also described is a method of automatically cooking a semi-solid liquid substance into a cooked food item, the method comprising automatically dispensing, under gravitational force, a desired quantity of at least one semi-solid liquid substance on at least one planar heating surface of at least one planar heating means; rotating about its axis the at least one planar heating means in the course of dispensing the at least one semi-solid liquid substance on the at least one planar heating surface for spreading the at least one semi-solid liquid substance on at least a part of the at least one heating surface; and attaining one or more cooking positions after the at least one semi-solid liquid substance is suitably spread on the at least a part of the at least one heating surface for cooking the at least one semi-solid liquid substance.

In an embodiment, the thickness of the desired food item is adjusted by varying the tilting position of the at least one planar heating means, and roast level of the desired food item is selected by varying the cooking time.

### BRIEF DESCRIPTION OF ACCOMPANYING DRAWINGS

The present invention, both as to its organization and manner of operation, together with further objects and advantages, may best be understood by reference to the following description, taken in connection with the accompanying drawings. These and other details of the present invention will be described in connection with the accompanying drawings, which are furnished only by way of illustration and not in limitation of the invention, and in which drawings:

FIGS. 1A, 1B and 2 illustrate a front three-dimensional view, a side view and an exploded view respectively of a disc-shaped automatic cooking apparatus comprising an electric heater plate oriented along vertical plane in accordance with an embodiment of the present subject matter.

FIG. 3 illustrates a rear three-dimensional view of a disc-shaped automatic cooking apparatus comprising an electric heater plate in accordance with an embodiment of the present subject matter.

FIG. 4 illustrates a rear view of a heater plate depicting tubular heater coil and heater plate rotating assembly in accordance with one embodiment of the present subject matter.

FIGS. 5A and 5B illustrate a front three-dimensional view and a side view respectively of a disc-shaped automatic cooking apparatus comprising an electric heater plate oriented in a tilted position in accordance with an embodiment of the present subject matter.

FIG. 6 illustrates a three-dimensional view of a disc-shaped automatic cooking apparatus configured to be operated in manual mode in accordance with an embodiment of the present subject matter.

FIGS. 7A to 13C illustrate various working positions of the disc-shaped automatic cooking apparatus in accordance with an embodiment of the present subject matter.

FIGS. 14a and 14b and 15 illustrate a three-dimensional view, a side view and an exploded view respectively of a disc-shaped automatic cooking apparatus comprising an induction stove oriented along vertical plane in accordance with an embodiment of the present subject matter.

FIG. 16 illustrates a rear three-dimensional view of a disc-shaped automatic cooking apparatus comprising an induction stove in accordance with an embodiment of the present subject matter.

FIG. 17 illustrates a front three-dimensional view of a disc-shaped automatic cooking apparatus comprising an induction stove oriented in a tilted position in accordance with an embodiment of the present subject matter.

FIGS. 18A and 18B illustrate three-dimensional views of a disc-shaped automatic cooking apparatus comprising an induction stove configured to be operated in manual modes in accordance with an embodiment of the present subject matter.

FIG. 19A and 19B illustrate three-dimensional views and sectional views of a front heater plate having a concave cooking surface and a convex cooking surface respectively in accordance with different embodiments of the present subject matter.

FIGS. 19C and 19D illustrates a top view of an elliptical heater plate and a three-dimensional view of a polygonal-shaped heater plate respectively in accordance with different embodiments of the present subject matter.

FIGS. 20A and 20B depict different positions of a motor operated feeder drive assembly in accordance with different embodiments of the present subject matter.

FIGS. 21A and 21F depict different positions of a cam operated feeder drive assembly in accordance with different embodiments of the present subject matter.

FIG. 22 depicts an exemplary view of a cooking area such as a kitchen with wall mounted disc shaped cooking apparatus in accordance with different embodiments of the present subject matter.

### DETAILED DESCRIPTION

The following presents a detailed description of various embodiments of the present subject matter with reference to the accompanying drawings.

The embodiments of the present subject matter are described in detail with reference to the accompanying drawings. However, the present subject matter is not limited to these embodiments which are only provided to explain more clearly the present subject matter to a person skilled in the art of the present disclosure. In the accompanying drawings, like reference numerals are used to indicate like components.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “attached” or “connected” or “coupled” or “mounted” to another element, it can be directly attached or connected or coupled to the other element or intervening elements may be present. As used herein, the term “and/or” includes any and all combinations and arrangements of one or more of the associated listed items.

The figures depict a simplified structure only showing some elements and functional entities, all being logical units whose implementation may differ from what is shown.

The present subject matter relates to a disc-shaped automatic cooking apparatus that is capable of cooking food items such as dosa, omelette, crepe, uthappam, pancake, and other similar dishes from semi-solid liquid substance. For the purpose of the present description, semi-solid liquid substance preferably comprises a semi-solid liquid food substance, also referred to as batter in the present description, having semi-solid liquid raw ingredients for cooking dosa, omelette, uthappam, crepe and other similar food products. The batter may comprise, in different embodiments, plain raw ingredients or may include finely cut fillings like onions, tomato etc. In an embodiment, the batter may comprise a mixture of more than one semi-solid liquid raw ingredients.

The cooking apparatus according to the present subject matter does not require human intervention during operation. The apparatus automatically dispenses batter on at least a part of the cooking surface in a uniform manner under gravitational force, performs the cooking operation by heating the dispensed batter, and serves the cooked food item to the user, as is described hereinbelow.

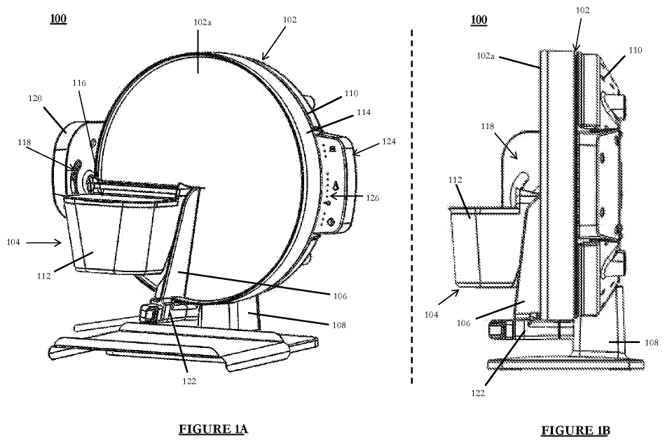

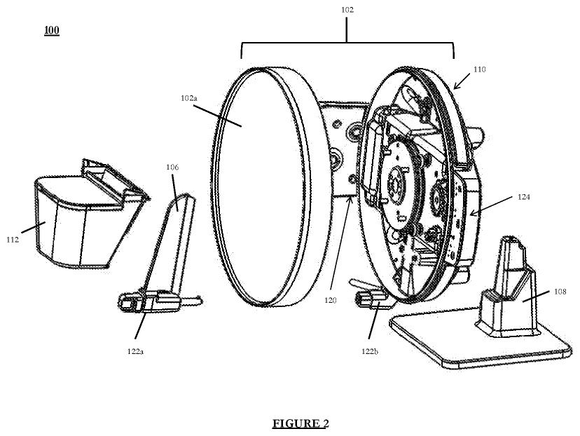

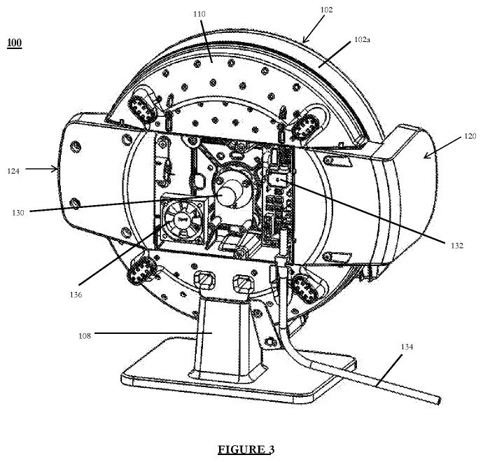

FIGS. 1A, 1B and 2 illustrate a front three-dimensional view, a side view and an exploded view respectively of a disc-shaped automatic cooking apparatus 100 comprising an electric heater plate oriented along vertical plane in accordance with an embodiment of the present subject matter. The cooking apparatus 100 according to the present embodiment is configured to cook food items, such as dosa, omelette, crepe, uthappam, pancake and other similar dishes automatically. The cooking apparatus 100 includes a plurality of components. For example, and by no way limiting the scope of the present subject matter, major components of the cooking apparatus 100 comprise at least one heater plate assembly 102 for heating and cooking a food item, at least one feeder tank assembly 104 swivelably mounted in relation to the heater plate assembly 102 for dispensing batter on the heater plate assembly 102, and an elongated blade 106. For the purpose of the present description, the expression ‘planar’ means being in a plane and the expression ‘planar heating means’ means a heating means having its surface aligned in a single plane.

In a preferred embodiment, the heater plate assembly 102 is oriented in a vertical configuration as shown in FIGS. 1A, 1B and 2. The vertical orientation of the heater plate assembly 102 means placement of the heater plate assembly 102 in the vertical plane, i.e., about 90 degrees from the horizontal surface. The heater plate assembly 102 is configured to be supported on a base structure 108, preferably an adjustable stand. The heater plate assembly 102 according to a preferred embodiment is configured in the form of a circular disc as shown in FIGS. 1A, 1B and 2.

In an embodiment, the heater plate assembly 102 comprises a planar heating means, particularly a front heater plate 102a having a planar heating surface that forms the cooking surface on which the batter is dispensed and food item from said batter is cooked. An electrical heating assembly comprising one or more heating elements is mounted besides the front heating plate 102a for supplying heat to the front heater plate 102a. In a preferred embodiment, the heating elements comprise one or more electric coils. The front heater plate 102a is configured to be rotated in the vertical plane about its axis (not shown) by means of a heater plate rotating assembly described later. The heater plate assembly 102 further comprises a plate support frame 110 mounted besides the front heater plate 102a for supporting the front heater plate 102a, as well as housing the heater plate rotating assembly and the electrical heating assembly in an embodiment. In a preferred embodiment, the front heater plate 102a is detachably mounted on the plate support frame 110.

The feeder tank assembly 104 comprises a feeder tank or storage tank 112 that is configured to store and dispense the batter on at least a part of the cooking surface and is removably mounted in the proximity of cooking surface of the front heater plate 102a. The feeder tank 112 extends along the radius of the front heater plate 102a. In an embodiment, the feeder tank 112 has an elongated configuration and extends from the center of the front heater plate 102a to the peripheral surface 114 of the front heater plate 102a. However, the size and configuration of the feeder tank 112 may vary depending upon the amount of batter to be stored therein. The size of the feeder tank 112 can be varied based on the batter storage requirement. Further, the shape of the feeder tank 112 is variable, i.e., is not limited to the one depicted in Figures and may vary as per the requirement. In an embodiment, the feeder tank 112 may extend throughout the diameter of the front heater plate 102a. The feeder tank 112 comprises a mouth opening 116 through which batter can be filled in the feeder tank 112 and also, dispensed on the cooking surface of the front heater plate 102a. In a preferred embodiment, the mouth opening 116 extends throughout the length of the feeder tank 112. However, the size and configuration of the mouth opening 116 may vary depending upon the amount of the batter to be dispensed on the cooking surface of the front heater plate 102a and the desired size of final cooked product.

The feeder tank assembly 104 further comprises a feeder drive assembly 118 for supporting and swiveling the feeder tank 112 about its axis. The feeder drive assembly 118 is housed inside a feeder drive housing 120. The feeder drive housing 120 is fixedly attached to the plate support frame 110 in an embodiment. One end of the feeder tank 112 is fixed to the feeder drive assembly 118 while the other end of the feeder tank 112 is mounted on the elongated blade 106 that is stationary. The mounting portions of the feeder tank 112 on the feeder drive assembly 118 and the elongated blade 106 may vary from those described above and depicted in figures as per the requirement. The elongated blade 106 is removably mounted in the radial direction on the cooking surface of the front heater plate 102a. One end of the removable blade is attached to the center of the front heater plate 102a and the other end is attached to the plate support frame 110 through a transverse bracket 122. In an embodiment, the transverse bracket 122 extends across the width of the front heater plate 102a as shown in FIGS. 1A, 1B and 2. In an embodiment, the transverse bracket 122 comprises a pair of mating transverse bracket components 122a, 112b wherein the first transverse bracket component 122a is fixedly attached to the elongated blade 106 and the second transverse bracket component 122b is fixedly attached to the plate support frame 110 in an embodiment. During assembly, the first transverse bracket component 122a and the second transverse bracket component 122b are detachably attached with each other in an embodiment.

In a preferred embodiment, the elongated blade 106 is mounted in the vertical direction, as shown in FIGS. 1A, 1B and 2, and is configured to peel the cooked food item from the front heater plate 102a. The placement of removable blade 106 with respect to the feeder tank 112 determines the size of food item to be cooked. In a preferred embodiment, angle defined by the feeder tank 112 and the elongated blade 106 in ready position is in the range of 180 to 280 degrees, preferably about 270 degrees, as shown in FIG. 1A. However, this angle may vary depending upon the requirement and desired size of the food item to be cooked. Therefore, in other embodiments, the angle defined by the feeder tank 112 and the elongated blade 106 in ready position may be less than 180 degrees and more than 280 degrees as per the requirement. In different embodiments, the elongated blade 106 may be mounted along the radius of the front heater plate 102a in an orientation different from that shown in FIGS. 1A, 1B and 2 without departing from the scope of the present invention.

A control panel 124 comprising an electronic control board 126 is mounted on the plate support frame 110 for operating the cooking apparatus 100. In an embodiment, the control panel 124 is integrated with the plate support frame 110. In an embodiment the control panel 124 is located diametrically opposite to the feeder drive housing 120. However, location of the control panel 124 can be varied in relation to the feeder drive housing 120 without departing from the scope of the present subject matter. In an embodiment, the electronic control board 126 comprises a digital interface unit for operating the cooking apparatus 100. In another embodiment, the electronic control board 126 can be replaced with a plurality of knobs. In yet another embodiment, the control panel 124 may comprise a combination of electronic control board and one or more knobs. In the assembled position, a removable collecting tray 128 is provided under the heater plate assembly 102 for collecting the cooked food item peeled by the elongated blade 106.

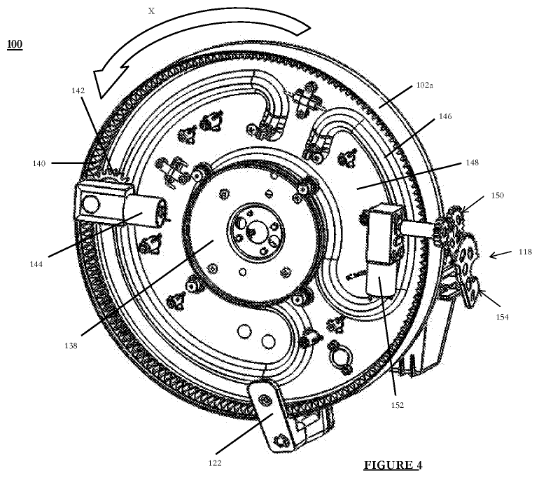

FIG. 3 illustrates a rear three-dimensional view of a disc-shaped automatic cooking apparatus 100 comprising an electric heater plate in accordance with an embodiment of the present subject matter. As shown herein, the feeder drive housing 120 and the control panel 124 are fixedly attached to the plate support frame 110 in a diametrically opposite manner. In an embodiment, feeder drive housing 120 and the control panel 124 form an integral part of the plate support frame 110. A rotary connector 130 is provided at the center of the heater plate assembly 102 for allowing rotary motion of the front heater plate 102a in relation to the plate support frame 100 during operation. A power board 132 is configured to supply power to electric components of the cooking apparatus 100 and a power cable 134 supplies power to the cooking apparatus 100 from an external power source. The excess heat in the cooking apparatus 100 is transferred to the atmosphere by means of a cooling fan 136. As can be seen in FIG. 3, the rotary connector 130, the power board 132 as well as the cooling fan 136 are housed inside the plate support frame 110 in an embodiment such that these and other components are shielded from external environmental conditions.

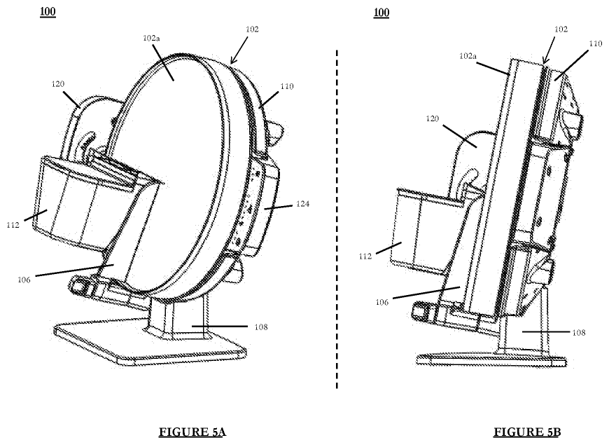

The plate support frame 110 also houses the electrical heating assembly and the heater plate rotating assembly of the apparatus 100. FIG. 4 illustrates a rear view of the front heater plate 102a depicting tubular heater coil and heater plate rotating assembly in accordance with one embodiment of the present subject matter. The front heater plate 102a is rotatably mounted on a heater plate holder 138 and the heater plate rotating assembly provides rotation to the front heater plate 102a. In an embodiment, the heater plate rotating assembly comprises one or more motion transmitting members, such as gears having mating teeth. The motion transmitting members may be integral to the front heater plate 102a or mounted in the heater plate assembly 102 as a separate unit in different embodiments. In a preferred embodiment, the heater plate rotating assembly comprises a plurality of circumferential teeth 140 on the inner side of the peripheral surface 114, a heater plate drive gear 142 having teeth configured to engage with circumferential teeth 140 and a heater plate drive motor 144. In an embodiment, the heater plate drive motor 144 is a dedicated motor that is powered to drive the heater plate drive gear 142. The heater plate drive gear 142 in turn rotates the front heater plate 102a by transmitting rotary motion to the front heater plate 102a through the engaging teeth of the heater plate drive gear 142 and circumferential teeth 140 of the peripheral surface 114. In an embodiment, the front heater plate 102a is rotated in clockwise direction as shown by arrow X, however, the direction of rotation may be anticlockwise in another embodiment without departing from the scope of the present subject matter. In another embodiment, the heater plate rotating assembly comprises a belt assembly for providing rotational motion to the front heater plate 102a. The electrical heating assembly of the present embodiment comprises a heating element 146 such as a tubular heating coil that is mounted on the rear surface 148 of the front heater plate 102a for transferring heat to the front heater plate 102a. In another embodiment, the heating element 146 may comprise an immersion heating element, flanged heating elements, screw plug heating elements or cartridge heaters as desired. In yet another embodiment, one or more than one heating element 146 may be employed in the apparatus 100.

As shown in FIG. 4, the feeder drive assembly 118 comprises a gear arrangement including but not limited to a plurality of feeder drive gear assembly 150 driven by a feeder drive motor 152 and a feeder lever 154 configured to be actuated by the feeder drive gear assembly 150 in an embodiment. The feeder lever 154 is configured to provide sweveling or tilting motion to the feeder tank 112 upon being actuated by the feeder drive gear assembly 150.

As can also be seen in FIG. 4, the transverse bracket 122 extends across the front heater plate 102a and is secured to the plate support frame 110 on the rear side of the heater plate assembly 102.

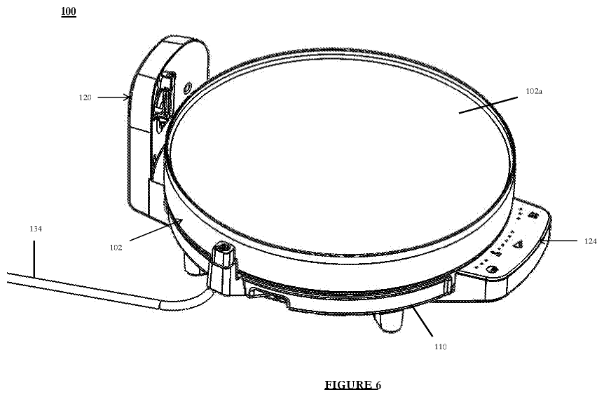

The embodiment of cooking apparatus of FIGS. 1A to 4 depict the heater plate assembly 102 in vertical position, i.e., 90 degrees from horizontal. However, the heater plate assembly 102 may be oriented at an angle other than 90 degrees from horizontal, i.e., the heater plate assembly 102 may be oriented in a tilted position in which the heater plate assembly 102 is positioned at an acute angle with respect to the vertical plane as shown in FIGS. 5A and 5B, which illustrate a front three-dimensional view and a side view respectively of a disc-shaped automatic cooking apparatus 100 in accordance with present embodiment. All the other components of the cooking apparatus 100 in the embodiment of FIGS. 5A and 5B are same as those explained hereinabove. In an embodiment, the heater plate assembly 102 may be configured to be adjusted by the user from vertical position as shown in FIGS. 1A to 4 to the tilted position as shown in FIGS. 5A and 5B and vice versa.

The cooking apparatus according to the embodiments described above is capable of cooking a food item, such as dosa, omelete, crepe etc. from batter in the automatic mode, i.e., without human intervention. In the automatic mode, the cooking apparatus 100 can be positioned in a slanting position, i.e., inclined with vertical plane, and/or vertically to execute the cooking process. During operation, the feeder tank 112 automatically dispenses a desired quantity of batter on the front heater plate 102a under gravitational force and simultaneously the disc-shaped front heater plate 102a rotates about its axis so that the batter is dispensed and printed appropriately on the cooking surface of the front heater plate 102a. After the batter is suitably printed on the front heater plate 102a as desired, the front heater plate 102a is allowed to cook and once the food item is prepared from the batter, the front heater plate 102a rotates again in the same direction so that the cooked food item is automatically peeled off by the elongated blade 106. In the embodiments described above, the cooking apparatus can be placed on a table or any other planar surface by means of the adjustable stand 108. In another embodiment, the cooking apparatus of the present subject matter can be wall mounted.

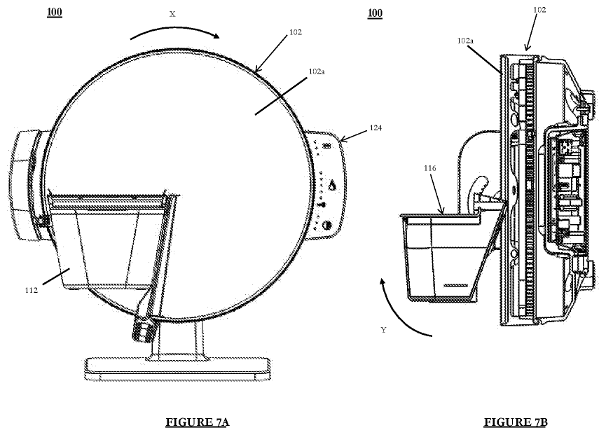

In another embodiment, the cooking apparatus 100 is capable of performing the cooking operation of a food item manually. In the manual mode, the heater plate assembly 102 can merely be placed horizontally on a planer surface, such as a table, after removing the feeder tank 112 therefrom, as shown in FIG. 6. In the manual mode, the cooking apparatus 100 can be used as a conventional hot plate and the horizontally placed front heater plate 102a can be used as a cooking surface for cooking food items.

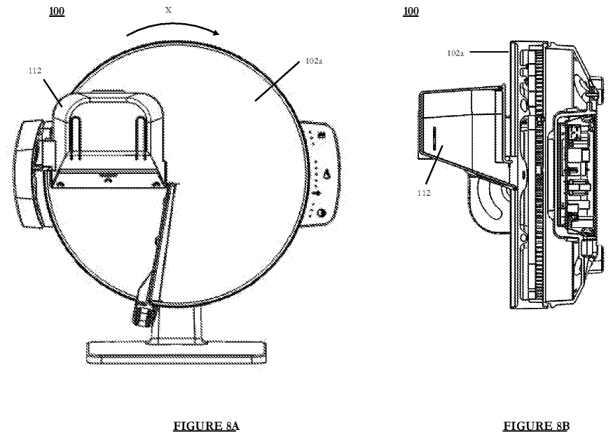

The working of the disc-shaped automatic cooking apparatus of the present invention will be described with reference to FIGS. 7A to 13C, which illustrate various working positions of the disc-shaped automatic cooking apparatus 100 in accordance with one embodiment of the present subject matter.

In the home position, as shown in FIGS. 7A and 7B, the cooking apparatus 100 is in the ready state or rest position. the elongated blade 106 is cleaned and fitted on the heater plate assembly 102. A semi-solid liquid substance or batter is filled into the feeder tank 112 and the feeder tank 112 is fitted in the proximity of cooking surface the heater plate assembly 102. In an alternate embodiment, the feeder tank 112 can be first fitted on the heater plate assembly 102 and then filled with batter. When the apparatus 100 is powered on and start button pressed, the apparatus 100 checks movement of the heater plate assembly 102 to make it complete position ready. Now heaters of the electrical heating assembly are turn ON. A user can select the number of food items to be cooked in the apparatus. The user can also vary thickness of the desired food items by varying the speed of the heater plate drive motor 144. In an embodiment, a thickness selection control is provided in the control panel 124 for selecting speed of the heater plate drive motor 144. In another embodiment, the thickness selection control may be replaced with a thickness selection knob. The thickness of the desired food item can also be adjusted by varying the tilting position of the heater plate assembly 102. Similarly, the roast level of the desired food item can be selected by varying the cooking time by selecting the cooking time control in the control panel 124.

Once the temperature of the front heater plate 102a reaches a pre-determined value, the feeder drive assembly 118 tilts or swivels the feeder tank 112 towards the cooking surface of the front heater plate 102a, as shown by arrow Y in FIG. 7B, such that the mouth opening 116 of the feeder tank 112 is positioned so as to dispense the batter through the feeder tank mouth opening 116 on the cooking surface of the front heater plate 102a. Simultaneously, the plate drive motor rotates the front heater plate 102a in the clockwise direction, as shown by arrow X in FIG. 7A, in an embodiment.

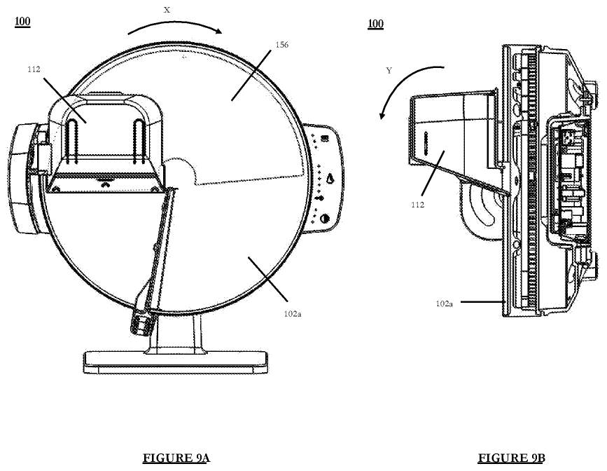

The tilted or dispensing position of the feeder tank 112 is depicted in FIGS. 8A and 8B. In this position, the front heater plate 102a starts to rotate in clockwise direction X. The rotation of the front heater plate 102a enables uniform dispensing or printing of batter from the feeder tank 112 over the cooking surface of the front heater plate 102a. Hence, this position can also be referred to as printing start position. FIGS. 9A and 9B depict an intermediary printing position of the front heater plate 102a when the front heater plate 102a has completed about half of its rotation. During rotation of the front heater plate 102a from the printing start position as depicted in FIGS. 8A and 8B to the intermediary printing position as depicted in FIGS. 9A and 9B, the batter is printed on the cooking surface of the front heater plate 102a. The printed batter on the front heater plate 102a is marked as 156 in FIG. 9A. In the intermediary printing position, the feeder tank 112 remains in the dispensing position. Once the required amount of batter is printed on the front heater plate 102a, the feeder tank 112 is swiveled/tilted back in the ready/home position in the direction of arrow Y′, as depicted in FIG. 9B, by the feeder drive assembly 118. When the feeder tank 112 is swiveled/tilted based in the ready/home position, the batter that is not dispensed on the front heater plate 102a is collected back and stored in feeder tank 112 for next printing operation.

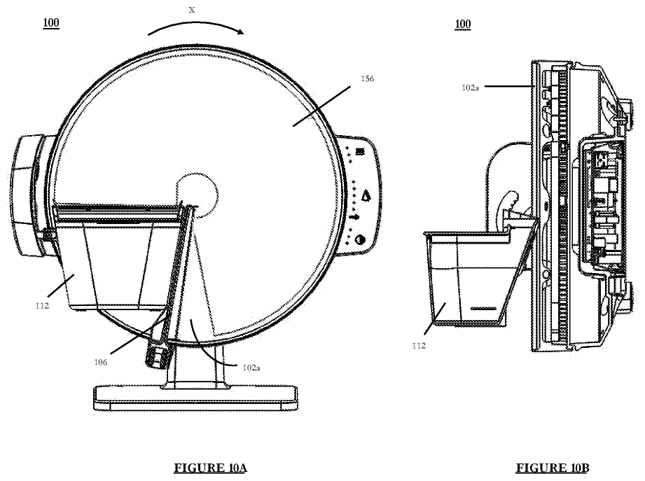

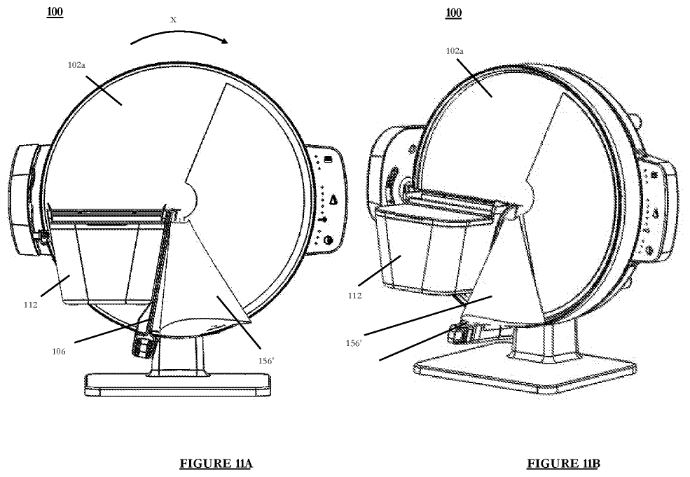

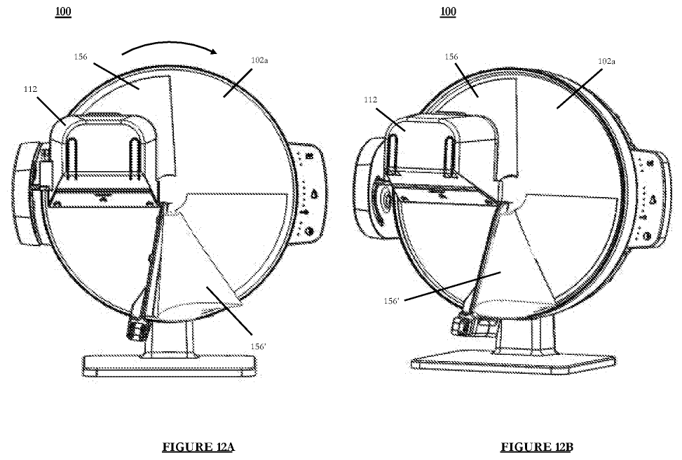

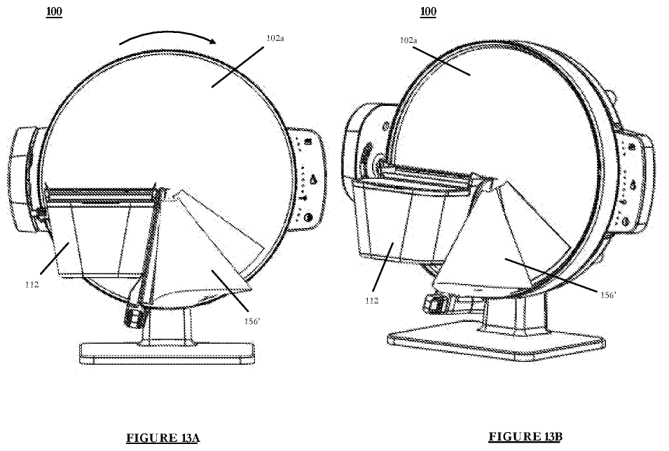

In the present embodiment, the tilting back of the feeder tank 112 to its ready/home position starts when the front heater plate 102a is rotated by about 270 degrees. In this position, the batter 156 is printed on about 3/4th surface of the front heater plate 102a as can be seen in FIG. 10A. FIGS. 10A and 10B depict the printing end position of the front heater plate 102a. In this position, rotation of the front heater plate 102a is stopped, and the batter 156 printed on the front heater plate 102a is allowed to cook at a pre-determined temperature for a pre-determined time duration. After the pre-determined time duration is over, the front heater plate 102a starts to rotate again in the same direction, as shown by arrow X in FIG. 10A. The further rotation of the front heater plate 102a enables automatic removal or peeling of the cooked food item 156′ from the front heater plate 102a by the elongated blade 106, as shown in FIGS. 11A and 11B. FIGS. 11A and 11B depict the cooked product removal position of the front heater plate 102a. During this step of peeling of the cooked food item, the feeder tank 112 again flips towards the cooking surface of the front heater plate 102a to simultaneously print the batter 156 on the front heater plate 102a for cooking a second food item, as shown in FIGS. 12A and 12B. FIGS. 12A and 12B depict the cooked product removal and next product printing position of the front heater plate 102a. Hence, removal of previous cooked food item 156′ and printing of new batter 156 on the front heater plate 102a takes place simultaneously. After printing of the second food item is finished, the feeder tank 112 again flips back to its home position. The process is repeated simultaneously up to the selected quantity of food items are cooked. For the final food item, as shown in FIG. 13A and 13B, the feeder tank 112 does not flip towards the front heater plate 102a, however, the final cooked food item 156′ is peeled by the elongated blade 106, thereby performing only the scrapping operation. Hence, removal of the final cooked food item 156′ alone is performed by the elongated blade 106 in this step without printing of batter. FIGS. 13A and 13B depict the final cooked food item 156′ removal position of the front heater plate 102a. The cooked food item 156′ after removal from the front heater plate 102a is collected in the tray 128. As can be seen in FIGS. 13A, 13B and 13C, the cooked food item 156′ removed from the front heater plate 102a has a conical shape. After completion of the above process, the elongated blade 106 and the feeder tank 112 can be removed from the cooking apparatus 100 for cleaning and maintenance purposes. One of the features of the removable feeder tank is that after all food items are prepared, the feeder tank 112 containing the remaining batter can be stored in refrigerator.

In an embodiment, the thickness of the cooked food item can be adjusted by any one or combination of steps comprising varying the viscosity of semi-solid liquid substance or batter, varying the angle of the heater plate assembly 102 with respect to the vertical plane, and varying the rotation speed of the front heater plate 102a. In an embodiment, viscosity of the semi-solid liquid substance or batter can be adjusted manually by the user. The angle of the heater plate assembly 102 with respect to the vertical plane can be adjusted by using the adjustable stand 108. In a preferred embodiment, the angle of the heater plate assembly 102 can be adjusted between 90°-70° with respect to the vertical plan. The rotation speed of the front heater plate 102a can be adjusted by using a variable speed motor in an embodiment.

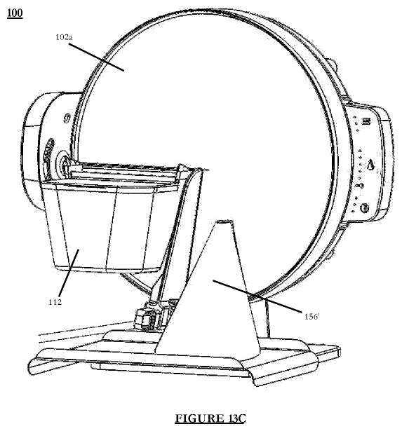

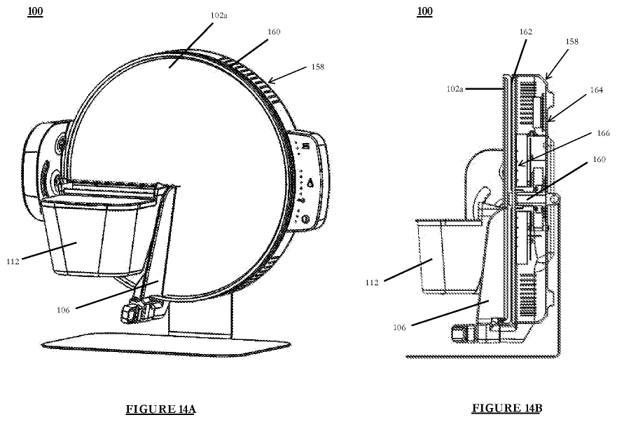

FIGS. 14a and 14b, 15 and 16 illustrate a three-dimensional view, a side view and an exploded view and a rear three-dimensional view respectively of a disc-shaped automatic cooking apparatus comprising an induction stove in an embodiment. Major components of the cooking apparatus 100 in the present embodiment, such as feeder tank 112, elongated blade 106, feeder drive assembly 118, control panel 124 and adjustable stand 108 are same as that in the previous embodiment. However, the tubular heater coil of the previous embodiment is replaced by an induction stove setup. In the present embodiment, the heater plate assembly 102 comprises an induction stove assembly 158 and is configured to be compatible for induction cooking. In an embodiment, the front heater plate 102a is removably mounted on a front heater plate holder 160, as shown in FIG. 14B. A glass plate 162 is provided between the front heater plate 102a and the induction stove assembly 158. As shown in FIG. 14B, the induction stove assembly 158 comprises an induction stove outer cover 164 that encompasses various components of the induction stove assembly 158. The induction stove assembly 158 comprises an induction coil 166 for generating heat and transferring said heat to the front heater plate 102a.

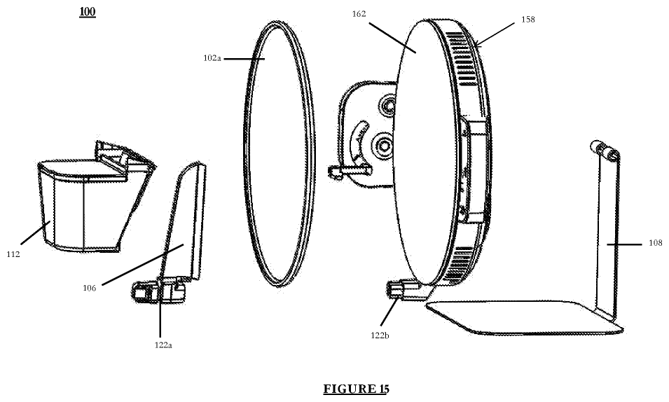

In the present embodiment, as shown in FIGS. 14B and 16, the heater plate rotating assembly comprises a plurality of heater plate drive gears 168a, 168b, 168c. A heater plate drive motor 170 actuates a motor-side heater plate drive gear 168a, which transmits rotatory motion to the plate-side heater plate drive gear 168c through an intermediate heater plate drive gear 168b. The plate-side heater plate drive gear 168c is attached to the heater plate holder 160 and rotates the heater plate holder 160 upon rotation, thereby rotating the front heater plate 102a by a desired angle. The cooling fan 136′ of the present embodiment is configured to dispense undesired heat from the cooking apparatus 100 into the atmosphere. The power board 132 is configured to supply power to the electric components of the cooking apparatus 100.

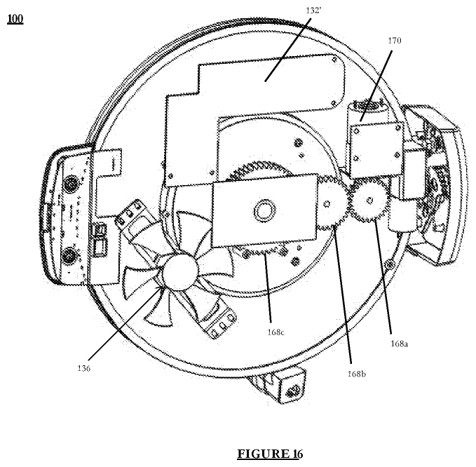

FIG. 17 illustrates a front three-dimensional view of a disc-shaped automatic cooking apparatus comprising an induction stove oriented in a tilted position in accordance with an embodiment of the present subject matter. As shown herein, the cooking apparatus 100 comprises an induction heating assembly in which the heater plate assembly 102 is oriented at an angle other than 90 degrees from horizontal, i.e., the heater plate assembly 102 is oriented in a tilted position in which the heater plate assembly 102 is positioned at an acute angle with respect to the vertical plane. All the other components of the cooking apparatus in the embodiment of FIG. 17 are the same as those explained in FIGS. 14A to 16. In an embodiment, the heater plate assembly 102 may be configured to be adjusted by the user from vertical position as shown in FIGS. 14A to 16 to the tilted position as shown in FIG. 17 and vice versa.

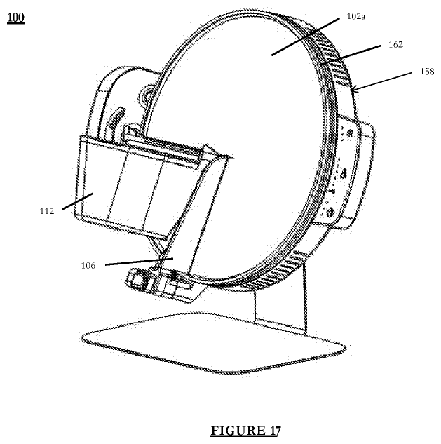

The cooking apparatus 100 with induction coil 166 as heating element according to the present embodiment, is also configured to cook a food item manually in a horizontal plane once detached from the adjustable stand 108. In the manual mode the heater plate assembly 102 of the cooking apparatus 100 can merely be placed horizontally on the table after removing the feeder tank 112 as shown in FIGS. 18A and 18B, which illustrate three-dimensional views of a disc-shaped automatic cooking apparatus comprising an induction stove configured to be operated in manual modes in accordance with an embodiment of the present subject matter. In the manual mode, the cooking apparatus 100 can be used as an induction compatible hot plate, as shown in FIG. 18A, in an embodiment wherein the horizontally placed front heater plate 102a can be used as a cooking surface for cooking food items. In another embodiment, the cooking apparatus 100 in manual mode can be used as a conventional induction stove by using the glass plate 162 as the heating surface after removing the front heater plate 102a. In this embodiment, all types of induction heat compatible utensils 172 can be used for cooking food items.

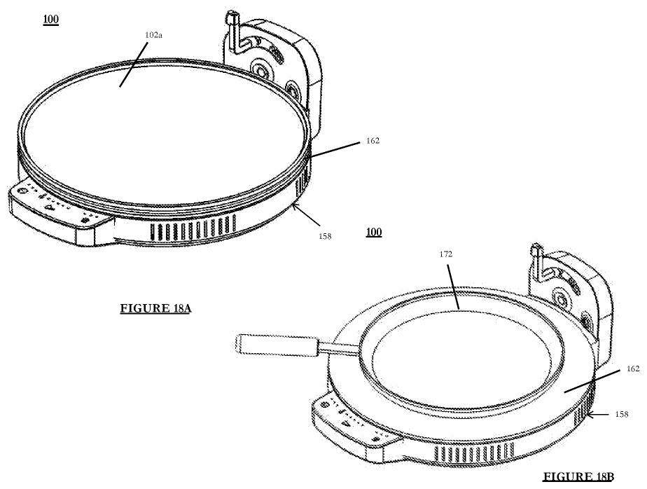

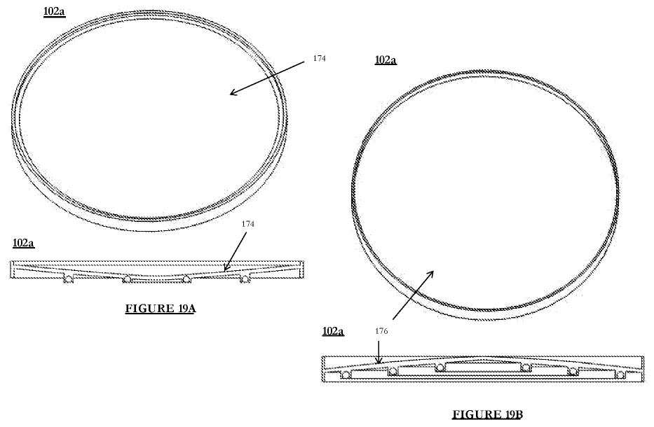

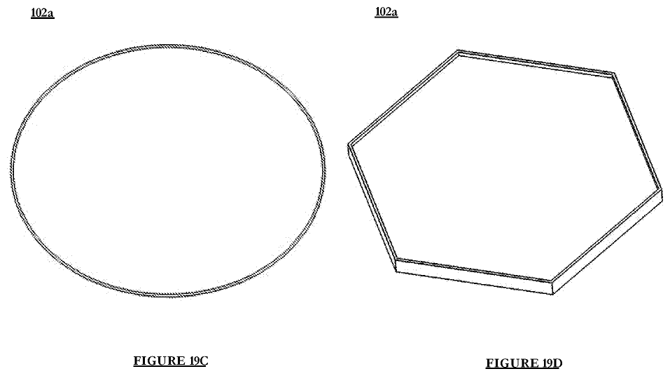

FIGS. 19A to 19D illustrate different embodiments of the front heater plate 102a that can be employed in the cooking apparatus 100. FIG. 19A depicts a top isometric view and a section view of a front heater plate 102a having a concave cooking surface 174 in an embodiment. FIG. 19B depicts a top isometric view and a section view of a front heater plate 102a having a convex cooking surface 176 in an embodiment. FIG. 19C depicts a top view of an elliptical-shaped front heater plate 102a in an embodiment. FIG. 19D depicts a top isometric view of a polygon-shaped front heater plate 102a in an embodiment.

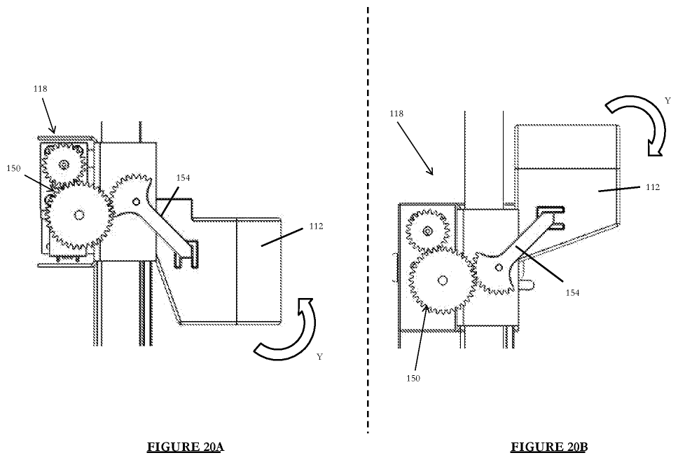

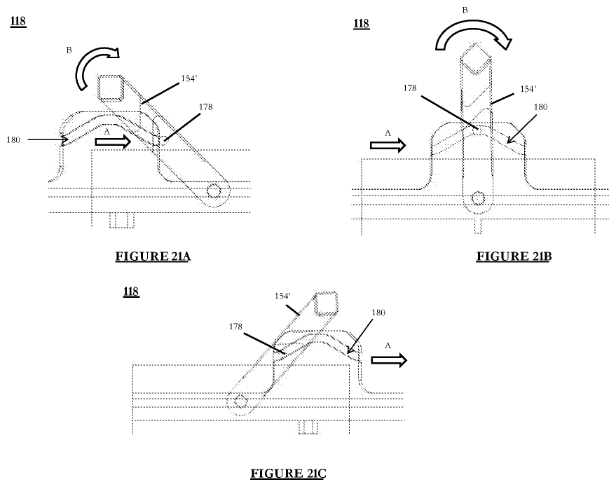

FIGS. 20A and 20B depict different positions of a motor operated feeder drive assembly 118 in accordance with an embodiment of the present subject matter. FIG. 20A depicts the position of the feeder drive assembly 118 when the feeder tank 112 is in ready/home position. The actuated/printing position of the feeder drive assembly 118 and hence, the rotated position of the feeder tank 112 is depicted in FIG. 20B. The feeder drive assembly 118 of the present embodiment comprises the feeder drive gear assembly 150 having a plurality of gears engaging with each other for transferring rotary motion to the feeder tank 112. One end of the feeder lever 154 engages with a gear of the feeder drive gear assembly 150 and its other end is pivotably attached to the feeder tank 112. Upon actuation by the feeder drive gear assembly 150, the feeder lever 154 tilts the feeder tank 112 in the direction of arrow Y, as shown in FIGS. 20A and 20B.

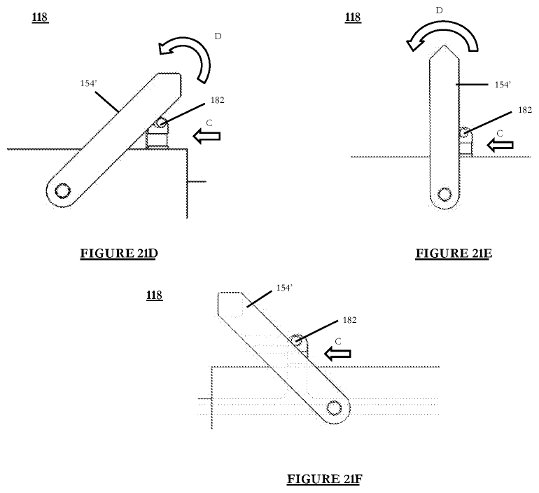

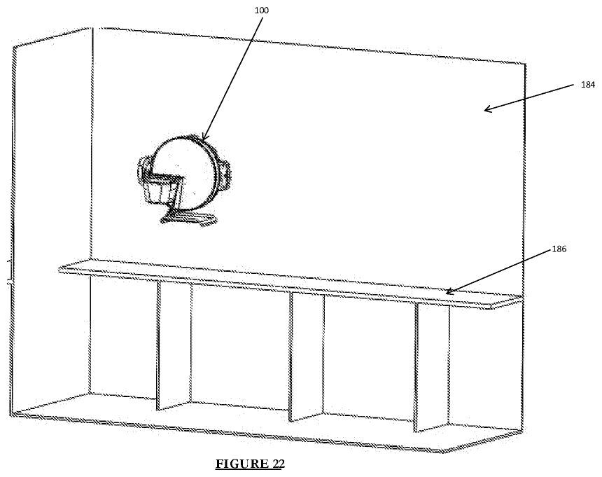

FIGS. 21A and 21F depict different positions of a cam operated feeder drive assembly in accordance with another embodiment of the present subject matter. FIGS. 21A to 21F illustrate a cam operated feeder drive assembly 118 according to another embodiment of the present subject matter. The mechanism for rotation of the feeder tank 112 from home/rest position to the printing position is shown in FIGS. 21A to 21C. In the present embodiment, the feeder lever 154′ includes a lever pin 178 that is configured to travel inside a cam profile 180 in the heater plate assembly 102. The feeder lever 156′ is shown in the home/ready position in FIG. 21A. As shown herein, the lever pin 178 is positioned at one end of the cam profile 180. With the movement of the cam profile 180 as shown by arrow A, the lever pin 178 starts to travel in the cam profile 180, thereby leading to rotation of the free end of the feeder lever 154′ as shown in arrow B. The intermediary position of the feeder lever 154′ during rotation is depicted in FIG. 21B and the final position of the feeder lever 154′ is depicted in FIG. 21C, which also corresponds to the printing position of the feeder tank 112.

The mechanism for rotation of the feeder tank 112 from printing position to the home/rest position is shown in FIGS. 21D to 21F. In the present embodiment, a pin 182 is mounted on the heater plate assembly 102 and the feeder lever 154′ rests on the pin 182 when the feeder tank 112 is in printing position as shown in FIG. 21D. The relative movement of the heater plate assembly 102 in the direction shown by arrow C results in rotation of the free end of the feeder lever 154′ due to its interaction with the pin 182 as shown by arrow D. The intermediary position of the feeder lever 154′ during rotation from printing position to the home/rest position is depicted in FIG. 21E and the final position of the feeder lever 154′ is depicted in FIG. 21F, which also corresponds to the home position of the feeder tank 112.

The feeder drive assembly 118 described above comprises a motor operated feeder drive assembly and cam operated feeder drive assembly in different embodiments. However, in other embodiments, the feeder drive assembly 118 may comprise a solenoid actuator operated feeder drive assembly or a feeder drive assembly that is operated by any other actuating mechanism.

The apparatus 100 according to the present invention is configured to be mounted on a horizontal surface such as a table in the embodiments shown in FIGS. 1A to 18B. However, in another embodiment, the apparatus 100 can also be configured to be mounted on a wall 184 in addition to being able to be mounted on the table 186 by providing corresponding provisions on the plate support frame 110. The wall mounted cooking apparatus 100 is depicted in FIG. 22 in an embodiment.

While the preferred embodiments of the present invention have been described hereinabove, it should be understood that various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

1. An automatic cooking apparatus comprising:
at least one planar heating means configured to be placed and operated in at least one inclined position and to rotate about its axis, the at least one planar heating means comprising at least one planar heating surface; and
at least one dispensing mechanism for automatically dispensing, under gravitational force, a desired quantity of at least one semi-solid liquid substance on the at least one heating surface; the at least one planar heating means, in the course of dispensing of the at least one semi solid liquid substance on the at least one heating surface, rotates about its axis to spread the at least one semi-solid liquid substance on at least a part of the at least one heating surface, and attains one or more cooking positions after the at least one semi-solid liquid substance is suitably spread on the at least a part of the at least one heating surface for cooking the at least one semi solid liquid substance.

2. The automatic cooking apparatus as claimed in claim 1, wherein the at least one planar heating means comprises a disc- or elliptical- or polygon-configuration having plane or concave or convex cooking surface.

3. The automatic cooking apparatus as claimed in claim 1, wherein the at least one planar heating means is configured to be placed and operated in vertical position, inclined position and horizontal position, and also to rotate in clockwise and/or anticlockwise by about 360 degrees or less than 360 degrees.

4. The automatic cooking apparatus as claimed in claim 1, wherein the at least one inclined position comprises an angular position of the at least one planar heating means between 0 to 90 degrees, preferably 0 degrees and between 60 to 90 degrees from horizontal.

5. The automatic cooking apparatus as claimed in claim 1, wherein at least one adjustable stand is provided to hold the at least one planar heating means at varying angles in said inclined position, particularly at 60 degrees and 90 degrees from horizontal.

6. The automatic cooking apparatus as claimed in claim 1, wherein the at least one dispensing mechanism comprises at least one storage tank for dispensing the at least one semi-solid liquid substance on the at least one heating surface, and wherein the at least one storage tank is configured to flip towards and away from the at least one planar heating means by a feeder drive assembly.

7. The automatic cooking apparatus as claimed in claim 6, wherein the feeder drive assembly comprises a motor operated or solenoid actuator operated or cam operated feeder drive assembly or a feeder drive assembly operated by any other actuating mechanism.

8. The automatic cooking apparatus as claimed in claim 1 further comprises an elongated blade removably mounted in the radial direction on the cooking surface of the at least one planar heating means for removing a cooked food item, prepared by cooking the at least one semisolid liquid substance on the at least one heating surface, from the at least one heating surface when the at least one planar heating means further rotates about its axis from the cooking position in the same direction such that the cooked food item removed from the at least one planar heating means has a conical shape.

9. The automatic cooking apparatus as claimed in claim 1 further comprises a plate support frame mounted besides the at least one planar heating means for supporting the at least one planar heating means, as well as housing a heater plate rotating assembly and an electrical heating assembly, and wherein the at least one planar heating means is detachable from the plate support frame.

10. The automatic cooking apparatus as claimed in claim 9, wherein the heater plate rotating assembly is operated by a gear mechanism or a belt mechanism or any other mechanism that enables rotation of the at least one planar heating means.

11. The automatic cooking apparatus as claimed in claim 9, wherein the electrical heating assembly comprises one or more heating elements comprising a tubular heating coil or an induction coil mounted besides the at least one planar heating means for supplying heat to the at least one planar heating means, and wherein the cooking apparatus with induction coil as heating element, once detached from the adjustable stand, is configured to be used manually in a horizontal plane.

12. The automatic cooking apparatus as claimed in claim 6, wherein the angle between the feeder tank and the elongated blade is in the range of 180 to 280 degrees, preferably about 270 degrees.

13. The automatic cooking apparatus as claimed in claim 1 further comprises provisions for mounting the automatic cooking apparatus on a wall.

14. A method of automatically cooking a semi-solid liquid substance into a cooked food item, the method comprising:
automatically dispensing, under gravitational force, a desired quantity of at least one semi-solid. liquid substance on at least one planar heating surface of at least one planar heating means; rotating about its axis the at least one planar heating means in the course of dispensing the at least one semi-solid liquid substance on the at least one planar heating surface for spreading the at least one semi-solid liquid substance on at least a part of the at least one heating surface; and
attaining one or more cooking positions after the at least one semi-solid liquid substance is suitably spread on the at least a part of the at least one heating surface for cooking the at least one semi-solid liquid substance.

15. The method as claimed in claim 14, wherein the thickness of the desired food item is adjusted by varying the tilting position of the at least one planar heating means and roast level of the desired food item is selected by varying the cooking time.
